(19) United States
(12) Patent Application Publication
(10) Pub. No.: US 2012/0311076 A1
(43) Pub. Date: Dec. 6, 2012

(54) SYSTEM AND METHOD TO SUPPORT DIFFERENT UNIFORM RESOURCE LOCATOR FORMATS FOR CONTENT ON DIFFERENT NETWORK ELEMENTS

(75) Inventors: Andrew James Rampulla, Harleysville, PA (US); John A. Schlack, Quakertown, PA (US)

(73) Assignee: Cisco Technology, Inc.

(21) Appl. No.: 13/481,350

(22) Filed: May 25, 2012

Related U.S. Application Data
(60) Provisional application No. 61/491,472, filed on May 31, 2011.

(51) Int. Cl. G06F 15/16

(52) U.S. Cl. 709/217

(57) ABSTRACT

A method is provided in one example embodiment and includes receiving a uniform resource locator (URL) at a content router; selecting at least a portion of a content delivery network to access content associated with the URL; and formatting the URL that was received based on the portion of the content delivery network that was selected. In more particular embodiments, the method can include parsing a source URL to extract a delivery service to format the URL that was received. Additionally, the method can include evaluating associated variables for the delivery service; applying a replacement pattern that utilizes the variables; and using the replacement pattern to construct a target URL format for a subsequent communication to the portion of the content delivery network.

### CROSS-REFERENCE TO RELATED APPLICATION

This Application claims the benefit of priority under 35 U.S.C. §119(e) to U.S. Provisional Patent Application Ser. No. 61/491,472 filed on May 31, 2011 and entitled “URL Transformation in CDN Element Routing,” which is hereby incorporated by reference in its entirety.

### TECHNICAL FIELD

This disclosure relates in general to the field of communications and, more particularly, to a system and a method to support different uniform resource locator formats for content on different network elements.

### BACKGROUND

End users have more media and communications choices than ever before. A number of prominent technological trends are currently afoot (e.g., more computing devices, more online video services, more Internet traffic), and these trends are changing the media delivery landscape. Content delivery networks (CDNs) serve a large fraction of the Internet content today, including web objects (text, graphics, URLs and scripts), downloadable objects (media files, software, documents), applications (e-commerce, portals), live streaming media, on demand streaming media, and social networks. Each Internet content item (or content fragment) has one or more uniform resource locators (URLs), which are used to access the content. However, different CDN providers use different URL formats to access the content. Hence, there is a challenge in providing the correct URL format for a selected CDN.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system to support different uniform resource locator formats for the same content on different network elements in accordance with one embodiment of the present disclosure;

FIG. 2 is a simplified block diagram illustrating possible example details associated with one embodiment of the present disclosure;

FIG. 3 a simplified flowchart illustrating potential operations associated with the communication system in accordance with one embodiment of the present disclosure;

FIGS. 4A-4B are simplified flowcharts illustrating potential operations associated with the communication system in accordance with one embodiment of the present disclosure;

FIG. 5 is another simplified flowchart illustrating potential operations associated with the communication system in accordance with one embodiment of the present disclosure;

FIG. 6 is another simplified flowchart illustrating potential operations associated with the communication system in accordance with one embodiment of the present disclosure; and

FIG. 7 is another simplified flowchart illustrating potential operations associated with the communication system in accordance with one embodiment of the present disclosure.

### DETAILED DESCRIPTION OF EXAMPLE EMBODIMENTS

### Overview

A method is provided in one example embodiment and includes receiving a uniform resource locator (URL) at a content router and selecting at least a portion of a content delivery network to access content associated with the URL. The portion can includes any one or more network elements. The method can also include formatting the URL that was received based on the portion of the content delivery network that was selected. In more particular embodiments, the method can include parsing a source URL to extract a delivery service to format the URL that was received. Additionally, the method can include evaluating associated variables for the delivery service; applying a replacement pattern that utilizes the variables; and using the replacement pattern to construct a target URL format for a subsequent communication to the portion of the content delivery network.

In yet other example implementations, a digital signature pattern that matches a digital signature of the URL is used to format the URL. Certain example methodologies may include validating the digital signature of the URL that was received by comparing the digital signature to a signature variable, where if no match exists between the signature variable and the digital signature, then a request for content is rejected. In alternative embodiments, the method can include determining if the digital signature matches a known digital signature pattern; and using the known digital signature pattern to determine a variable pattern for the URL.

Certain example implementations may include configuring a content router with a list of delivery services; receiving a routing request; and matching a selected one of the delivery services with a subset of the URL by performing a string comparison. In yet other instances, the method can include defining a set of regular expressions; applying a selected one of the regular expressions to the URL; and extracting a delivery service name based on the selected one of the regular expressions. The method can also include determining a cache miss; and using the content router as an origin for particular content requested by a particular content delivery network.

### Example Embodiments

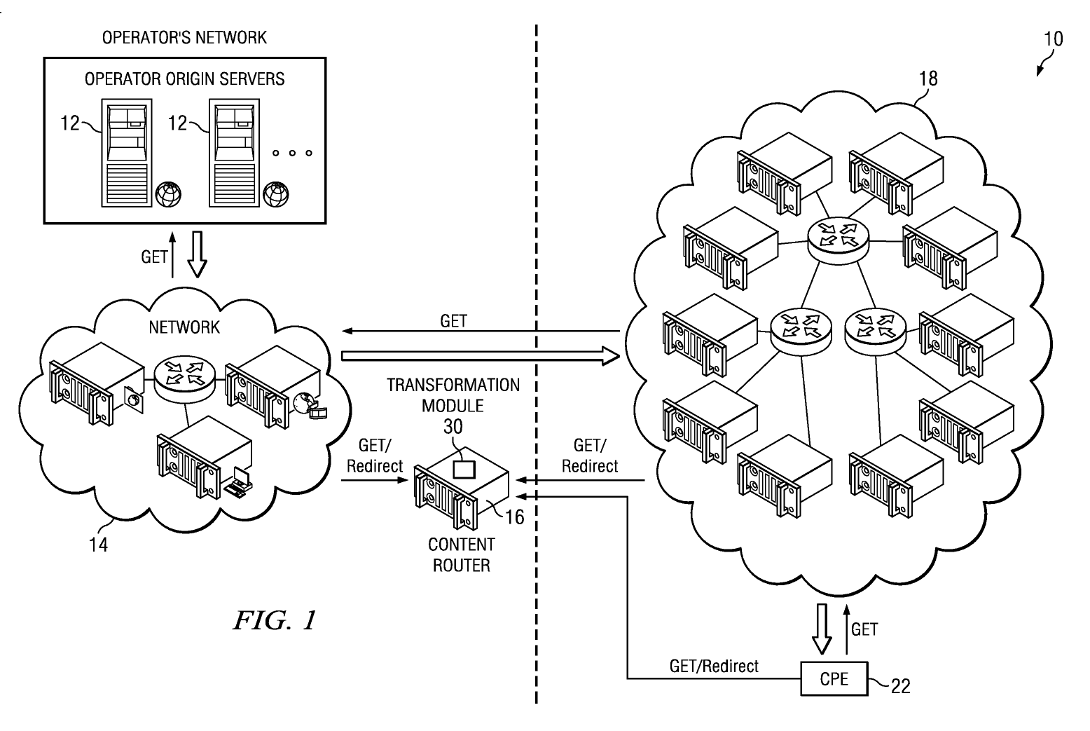

Turning to FIG. 1, FIG. 1 is a simplified block diagram of a communication system 10 configured for supporting different uniform resource locator formats for the same content on different network elements in accordance with one embodiment of the present disclosure. Communication system 10 includes a plurality of content sources 12, a first network 14 (e.g., an originating content delivery network (CDN)), a content router 16, a second network 18 (e.g., an enlisted CDN), and an instance of customer premise equipment (CPE) 22. Content router 16 can include a transformation module 30 in a particular implementation of the present disclosure.

Content router 16 may be configured to deliver requested content to CPE 22. Content router 16 may be a request router, a content router, or some other similar device that can route a content request to different CDNs, or different elements within a CDN. Routing may be performed using various different methods including Hypertext Transfer Protocol (HTTP) redirect, Domain Name System (DNS), or web service calls. When a CDN or CDN element has a cache miss, it consults the content router either directly (HTTP redirect, web service) or indirectly (DNS) to locate the element in the next cache tier or the origin from which to retrieve content.

Communication system 10 can be configured to route requests between an enlisted CDN (e.g., network 18) and an originating CDN (e.g., network 14) using a URL transformation. More specifically, communication system 10 can transform URL formats for different CDNs without encoding support for the URL transformation into the actual URL format for a CDN or CDN element. In addition, communication system 10 can perform URL transformations for routing between different elements within the same CDN

For purposes of illustrating certain example techniques of communication system 10, it is important to understand the communications that may be traversing the network. The following foundational information may be viewed as a basis from which the present disclosure may be properly explained. A (CDN) is a distributed system of servers, computers, and/or network elements (e.g., gateways, routers, switches, caches, etc.) deployed in multiple data centers in a service provider's network or on the Internet. The typical goal of a CDN is to serve content to end users with high availability and high performance. CDNs serve a large fraction of the content on the Internet today, including web objects (text, graphics, URLs, and scripts), downloadable objects (media files, software, documents), applications (e-commerce, portals), live streaming media, on demand streaming media, and social networks. Each content item or content fragment has one or more URLs, which are used to access the content, and different CDN providers use different URL formats to access that content.

In an environment where the originating CDN enlists one or more CDNs to deliver the content to the destination, the URL may need to be transformed between the CDNs in order for the delivery to be successful. In addition, a CDN may be comprised of elements (e.g. cache nodes) from different vendors. When a CDN element at one tier of the CDN retrieves content from a CDN element at a different tier, and those CDN elements originate from different vendors, the URL may need to be transformed to retrieve content from the CDN element from the different vendor.

In accordance with one example implementation of the present disclosure, communication system 10 can resolve the aforementioned issues (and potentially others) associated with supporting different uniform resource locator formats for the same content on different network elements. In one example implementation, after a client (e.g., CPE 22) selects content through an operator's portal associated with the client, the portal directs the client to a content router (e.g., content router 16) to access the content using the provided URL. The content router may determine that the client is best served by enlisting a peer CDN (e.g., network 18). The content router performs a URL transformation to convert the URL to a format supported by the enlisted CDN and directs the client to access the content using the transformed URL. The client uses the transformed URL returned by the content router to access the content from the enlisted CDN. The enlisted CDN requests the content from an originating CDN (e.g., network 14)

The originating CDN requests the content from the origin server (e.g., content source 12) and the origin server delivers the content to the originating CDN. The originating CDN delivers the content to the enlisted CDN and the enlisted CDN delivers the content to the client. There are multiple points in the content delivery process where the content router may need to transform a URL in order for each CDN or element within each CDN to locate the requested content.

In one example, on a cache miss, the enlisted CDN can use the content router as the origin. When the content router receives the content request, it may select the originating CDN as the source, performs a URL translation to convert the URL to a format supported by the originating CDN, and directs the enlisted CDN to access the content using the transformed URL. Note that the content router may use a combination of HTTP Redirect and DNS to direct the enlisted CDN to the originating CDN. The enlisted CDN can use the transformed URL returned by the content router to access the content from the originating CDN.

In another example, on a cache miss, the originating CDN can use the content router as the origin. When the content router receives the content request, it may select the origin server associated with the requested content, perform a URL translation to convert the URL to a format supported by the origin server, and direct the originating CDN to access the content using the transformed URL. Note that the content router may use a combination of HTTP Redirect and DNS to direct the originating CDN to the origin. In an embodiment, the originating CDN may already be configured to access content from the appropriate origin server.

In an embodiment, a database can associate a content ID in a URL with possible URL formats that may be available to the content router (e.g., in transformation module 30). In this case, a request is made to the content router for a specified content item. The content router selects a CDN on which to deliver the content, looks up the target CDN provider in the mapping table, and determines the URL format of the content for that CDN. The formatted URL is then returned to the consumer and normal CDN delivery can be completed.

In an illustrative example, Table 1 below shows the mapping of 2 different content IDs to 2 different CDNs (i.e., CDN A, identified by CDN identifier CDN_A, and CDN B, identified by CDN identifier CDN_B) managed by the content router. Note that this also applies to different CDN elements within the same CDN.

TABLE 1

| | CDN | |
|---|---|---|
| Content Id | Identifier | Target URL |
| /AAAA | CDN_A | http://service.cdn.mycompany.com/AAAA |
| /AAAA | CDN_B | http://files.mycompany.com/0178/net1/AAAA |
| /BBBB | CDN_A | http://service.cdn.mycompany.com/BBBB |
| /BBBB | CDN_B | http://files.mycompany.com/0201/net2/BBBB |

In one example, using Table 1, the content router receives a request for http://contentrouter.mycompany.com/BBBB. If CDN A is selected, the content router returns http://service.cdn.mycompany.com/BBBB (the URL format for CDN A). If CDN B is selected, the content router returns http://files.mycompany.com/0201/net2/BBBB (the URL format for content CDN B).

In another embodiment, a delivery service specified in the request is used to map a set of variables. A delivery service is an identifier of a set of content that has the same content acquisition and distribution rules. The delivery service is typically from the same content provider and sourced from the same origin. The delivery service is embedded within the hostname of the URL as this allows routing based on DNS, in addition to routing based on HTTP Redirect and web service. The variables from the delivery service plus the path portion of the URL can then be used in the replacement URL. For example, in the URL http://xyz.broadcasters.cdn.mycompany.com/AAA the delivery service is xyz.broadcasters. Note that the delivery service does not need to be listed first. In another example, a cache node identifier can be included in the hostname of the URL http://node1A.xyz.broadcasters.cdn.mycompany.com/AAA. In this example, the delivery service is still “xyz.broadcasters.”

The content router may be pre-configured with a list of delivery services. When the content router receives a routing request, it can attempt match the delivery service with a subset of the URL by performing a string comparison. If a match is found, then the delivery service has been identified, and the URL can be formatted. As an alternative to pre-configuring the list of known delivery services, a set of regular expressions can be defined. When the regular expression is applied to the URL, it extracts the delivery service name. This process works when the delivery service name follows a well-known rule, such as “the delivery service from CDN A always ends with ‘cdn.mycompany.com’”. Typically, each CDN or CDN element will follow one of a small set of standardized URL formats. Hence, if the originator of the request is known, the correct regular expression can be used to extract the delivery service. For example, the regular expression “http://(.*?)\\.cdn.mycompany.com.*” may extract “xyz.broadcasters” from the URL http://xyz.broadcasters.cdn.mycompany.com/AAA.

Once the list of known delivery services has been pre-configured or regular expressions have been created to extract the delivery service names, CDN specific path variables are associated with each delivery service, which can be used as replacement parameters in the transformed URL. By parsing the source URL to extract the delivery service, and looking up the associated variables for that delivery service, a replacement pattern can be applied that can utilize those variables determined in the lookup. The replacement pattern can then be used to construct the target URL format. For example, as illustrated in Table 2, if a particular CDN has CDN specific path variables of “CustomerId” and “VirtualFolder, the delivery service “xyz.broadcasters” could be associated with the CDN path variables such that CustomerId=“0178” and VirtualFolder=“/xyzfolder.

TABLE 2

| | |
|---|---|
| Delivery Service | xyz.broadcasters |
| Path Variables | CustomerId=0178 |
| | VirtualFolder=xyzfolder |
| Replacement Pattern | http://files.CDN X.com/${CustomerId}${VirtualFolder}/${Path} |
| Source URL | http://xyz.broadcasters.cdn.mycomany.com/AAA |
| Generated Target URL | http://files.CDN X.com/0178/bbcfolder/AAA |

In another example, as illustrated in Table 3, if a particular CDN has CDN specific path variables of “CustomerId” and “VirtualFolder, the delivery service “abc.broadcasters” could be associated with the CDN path variables such that CustomerId=“2108” and VirtualFolder=“/abcfolder”.

TABLE 3

| | |
|---|---|
| Delivery Service | abc.broadcasters |
| Path Variables | CustomerId=2108 |
| | VirtualFolder=abcfolder |
| Replacement Pattern | http://files.CDN X.com/${CustomerId}${VirtualFolder}/${Path} |
| Source URL | http://abc.broadcasters.cdn.mycomany.com/AAA |
| Generated Target URL | http://files.CDN X.com/2108/abcfolder/AAA |

In another embodiment, rules (in transformation module 30) which can map from one URL format to another without having to explicitly configure URLs for each content item or content fragment are used. The rules based mapping is more flexible than delivery service based mapping, since it is not limited to mapping URL formats solely based on the delivery service. In rules based mapping, a rule can be created with a regular expression for extracting any parts of the request URL and a replacement expression can then construct the CDN specific (or CDN element specific) URL. Two sets of rules may be defined for rules based mapping: matching rules and replacement rules.

Matching rules are a combination of a single regular expression and several variable expressions. A regular URL expression (e.g., http://en.wikipedia.org/wiki/Regular_expression) (or similar syntax for defining expressions) can support the concept of capture groups. The variable expressions can be a pair of name/expression values that use the capture groups from the regular expression to create new variables.

One purpose of the replacement rule is to construct any additional variables (or replace existing variables) that were not constructed in the matching rules phase. In this case, the original URL and the variables created from the matching rule are passed to the replacement rule. The replacement rule then constructs any additional variables using any set of rules desired to create a replacement expression. The replacement expression is a simple expression that can be used to generate the remapped URL. It defines a series of variables that can be replaced using the results of the replacement rules. In the illustrated example the variable format of ${variableName} is used to delineate variables to be replaced, however, the variables can be delimited by any criterion selected by an administrator or user. Note that if the “${” string is to be used in the actual URL, it should be escaped with “\”.

It should be noted that many sets of mapping rules may exist. There may be one or more sets of mapping rules for each combination of CDN vendor requesting the content to CDN vendor sourcing the content. In one example, CDN A may use a delivery service in its URL and CDN X may not use a deliver service in its URL.

An example of a matching rule is illustrated below where a delivery service is identified by the data in the position (.*?) and the content ID is identified by the data in the position (.*).

| Regular Expression | Variable Expression |
|---|---|
| http://(.*?)\\.cdn\\.mycompany\\.com/(.*) | deliveryService=$1 |
| | contentId=$2 |

The example illustrated in Table 4 demonstrates how to map from a URL format with a delivery service (CDN A) to a different URL format that identifies a folder structure instead of delivery service in its URL (CDN X).

TABLE 4

| | |
|---|---|
| CDN A URL | http://xyz.broadcaster.cdn.mycompany.com/AAAAAAA |
| Matcher | http://(.*?)\\.cdn\\.mycompany\\.com/(.*) |
| Variable | deliveryService=Matcher.$1 |
| Pattern | contentId=Matcher.$2 |
| Replacement | When ${deliveryService} matches “xyz.broadcaster” |
| Rule | Then ${CustomerId} = “0178” and |
| | ${VirtualFolder} = “xyzfolder” |
| | When ${deliveryService} matches “abc.broadcaster” |
| | Then ${CustomerId} = “2108” and |
| | ${VirtualFolder} = “abcfolder” |
| Replacement | http://files.CDN |
| Expression | X.com/${CustomerId}/${VirtualFolder}/${ContentId}/data |
| CDN X URL | http://files.CDN X.com/0178/xyzfolder/AAAAAAA/data |

More specifically, the incoming URL originates from a CDN or CDN element that supports a CDN A URL format. This is matched against the first rule whose matcher indicates a match. In this case, the rule can generate the variables “deliveryService” and “contentId”. The deliveryService has a value of “xyz.broadcaster” and the contentId has a value of “AAAAAAA”.

Next the replacement rule associated with this matcher rule may be run. This can create two new variables “CustomerId” and “VirtualFolder”. Since the deliveryService value is “xyz.broadcaster”, the CustomerId value is “0178” and the VirtualFolder value is “xyzfolder”. All of these variables can be used in the replacement URL to generate the CDN X URL shown in Table 4.

In another example, illustrated in Table 5, the incoming URL originates from a CDN or CDN element that supports the CDN X URL format. This can be matched against the first rule whose matcher indicates a match. In this case, the rule can generate the variables “customerId”, “virtualFolder”, and “contentId”. The customerId value is “0178”, the virtualFolder value is “xyzfolder”, and the contentId value is “AAAAAAA”.

Next the replacement rule associated with this matcher rule may be run. This can create a single new variable “deliveryService”. Since the contentId is “0178”, the value of deliveryService is “xyz.broadcaster”. All of these variables can be used in the replacement expression to generate the CDN A URL illustrated in Table 5.

TABLE 5

| | |
|---|---|
| CDN X URL | http://files.CDN X.com/0178/xyzfolder/AAAAAAA/data |
| Matcher | http://files.CDN X.com/(.*?)/(.*?)/(.*?)/data |
| Variable Patterns | customerId=Matcher.$1 |
| | virtualFolder=Matcher.$2 |
| | contentId=Matcher.$3 |
| Replacement Rule | When ${customerId} matches “0178” |
| | Then ${deliveryService} = “xyz.broadcaster” |
| | When ${customerId} matches “2108” |
| | Then ${deliveryService} = “abc.broadcaster” |
| Replacement Expression | http://${deliveryService}.cdn.mycompany.com/${contentId} |
| CDN A URL | http://xyz.broadcaster.cdn.mycompany.com/AAAAAAA |

In another embodiment, keys (in transformation module 30) can be synchronized with original URL signatures so content router 16 can re-sign a transformed URL. The idea behind URL signing is to authenticate that the request came from an authorized user. Since the content router is rewriting the URL, without a valid signature, there is very little chance that the signed portion of the transformed URL is still valid for the new URL and systems that rely on URL signing may not deliver the requested content. In order to cope with this issue, content router 16 can introduce a key store. Additionally the replacement rule may be configured to provide a correct alias to load a key that can be used to re-sign the rewritten URL, a hashing method to generate the hash, an encryption type, and a key length to generate the digital signature.

In an embodiment, transformation module 30 may be configured to have a regular expression that describes how to sign the request as well as how to validate that the original request was signed properly. Table 6 lists some example parameters for this rule.

TABLE 6

| | |
|---|---|
| Signing Matcher | http://(.*?)/(.*?)digitalSignature=(.*) |
| Signed Path Pattern | sourcePath=Matcher.$2 |
| | (note this example doesn't sign the |
| | hostname portion) |
| Signature Pattern | sourceSignature=Matcher.$3 |
| Decryption Key Alias | DECRYPT_KEY_ALIAS |
| Variable Name | |
| Encryption Key Alias | ENCRYPT_KEY_ALIAS |
| Variable Name | |
| Hash Method Variable Name | HASH_METHOD |
| Key Length Variable Name | KEY_LENGTH |
| Encryption Type Variable | ENCRYPTION_TYPE |
| Name | |

In an embodiment, an incoming URL that originates from a CDN or CDN element that supports the CDN A URL format can be matched against the first rule whose matcher returns a match. As illustrated in Table 7, a rule can generate the variables “deliveryService” and “contentId”. In this example, the values of these variables are “xyz.broadcaster” and “AAAAAAA” respectively.

TABLE 7

| | |
|---|---|
| CDN A URL | http://xyz.broadcaster.cdn.mycompany.com/AAAAAAA?digitalsignature= |
| | XXXXX |
| Matcher | http://(.*?)\\.cdn\\.mycompany\\.com/(.*)[&\\?]digitalsignature=(.*) |
| Variable Pattern | deliveryService=Matcher.$1 |
| | contentId=Matcher.$2 |
| Signing Matcher | http://(.*?)/(.*?)digitalSignature=(.*) |
| Variable Pattern | sourcePath=SigningMatcher.$2 |
| | sourceSignature =SigningMatcher.$3 |
| Validation Rule | When anything |
| | Then ${DECRYPT_KEY_ALIAS} = “defaultAlias” |

and ${ENCRYPT_KEY_ALIAS} = “defaultAlias”
and ${HASH_METHOD} = “SHA2”
and ${ENCRYPTION_TYPE} = “RSA”
and ${KEY_LENGTH} = 1024

| | |
|---|---|
| Replacement Rule | When ${deliveryService} matches “xyz.broadcaster” |
| | Then ${CustomerId} = “0178” and ${VirtualFolder} = “xyzfolder” |
| | When ${deliveryService} matches “abc.broadcaster” |
| | Then ${CustomerId} = “2108” and ${VirtualFolder} = “abcfolder” |
| Replacement | http://files.CDN |
| Expression | X.com/${CustomerId}/${VirtualFolder}/${ContentId}/data? |
| | digitalsignature=${newDigitalSignature} |
| CDN X URL | http://files.CDN |
| | X.com/0178/xyzfolder/AAAAAAA/data?digitalsignature=ZZZZZZ |

More specifically, a signing matcher can be matched against a CDN A URL format. If a match exists, this can produce the “sourcePath” and “sourceSignature” variables. These have values “AAAAAAA” and “XXXXXX” respectively. Note that based on the different signing methods, other variables may be created to extract query parameters such as client IP address, request expiration date, etc.

A validation rule may be run and the rule can create a set of variables used to validate the signed URL request. These variables can include “DECRYPT_KEY_ALIAS”, “ENCRYPT_KEY_ALIAS”, “HASH_METHOD”, “ENCRYPTION_TYPE”, “KEY_LENGTH”. Using the validation variable and variables from the signing matcher, a digital signature can be generated and validated against a variable (e.g., the sourceSignature variable). If these do not match, the request is rejected. A replacement rule associated with the matcher rule can also be run. This can create two new variables “CustomerId” and “VirtualFolder”. Since the deliveryService value is “xyz.broadcaster”, the CustomerId value is “0178” and the VirtualFolder value is “xyzfolder”.

Many of these variables can be used in the replacement expression to generate the URL for CDN X. However, the URL has not been signed yet. As a last operation, a new digital signature is generated using the CDN X URL and the URL signing variables generated by the validation rule and signing matcher. The digital signature can be added to the final URL to create the CDN X URL shown in Table 7.

Turning to the example infrastructure associated with present disclosure, CPE 22 can be associated with devices, customers, or end users wishing to receive data or content in communication system 10 via some network. The term ‘content receiver’ is inclusive of devices used to initiate a communication, such as a receiver, a computer, a set-top box, an Internet radio device (IRD), a cell phone, a smart phone, a tablet, a personal digital assistant (PDA), a Google droid, an iPhone, and iPad, or any other device, component, element, or object capable of initiating voice, audio, video, media, or data exchanges within communication system 10. CPE 22 may also be inclusive of a suitable interface to the human user, such as a display, a keyboard, a touchpad, a remote control, or other terminal equipment. CPE 22 may also be any device that seeks to initiate a communication on behalf of another entity or element, such as a program, a database, or any other component, device, element, or object capable of initiating an exchange within communication system 10. Data, as used herein in this document, refers to any type of numeric, voice, video, media, or script data, or any type of source or object code, or any other suitable information in any appropriate format that may be communicated from one point to another.

Network 14 and network 18 each represent a series of points or nodes of interconnected communication paths for receiving and transmitting packets of information that propagate through communication system 10. Network 14 and network 18 each offer a communicative interface between sources and/or hosts, and may be any local area network (LAN), wireless local area network (WLAN), metropolitan area network (MAN), Intranet,

Extranet, WAN, virtual private network (VPN), or any other appropriate architecture or system that facilitates communications in a network environment. A network can comprise any number of hardware or software elements coupled to (and in communication with) each other through a communications medium.

In one particular instance, the architecture of the present disclosure can be associated with a service provider digital subscriber line (DSL) deployment. In other examples, the architecture of the present disclosure would be equally applicable to other communication environments, such as an enterprise wide area network (WAN) deployment, cable scenarios, broadband generally, fixed wireless instances, fiber to the x (FTTx), which is a generic term for any broadband network architecture that uses optical fiber in last-mile architectures, and data over cable service interface specification (DOCSIS) cable television (CATV). The architecture of the present disclosure may include a configuration capable of transmission control protocol/internet protocol (TCP/IP) communications for the transmission and/or reception of packets in a network.

Content router 16 and CDN devices (in networks 14 and 18) are network elements that can facilitate the support of different URL formats discussed herein. As used herein in this Specification, the term ‘network element’ is meant to encompass any of the aforementioned endpoints, as well as routers, switches, cable boxes, gateways, bridges, loadbalancers, firewalls, inline service nodes, proxies, servers, processors, modules, or any other suitable device, component, element, proprietary appliance, or object operable to exchange information in a network environment. These network elements may include any suitable hardware, software, components, modules, interfaces, or objects that facilitate the operations thereof. This may be inclusive of appropriate algorithms and communication protocols that allow for the effective exchange of data or information.

In one implementation, content router 16 includes software to achieve (or to foster) activities associated with providing different URL formats, as discussed herein. This could include the implementation of instances of transformation module 30. Additionally, each element can have an internal structure (e.g., a processor, a memory element, etc.) to facilitate some of the operations described herein. In other embodiments, the support of different URL formats may be executed externally to these elements, or included in some other network element to achieve the intended functionality. Alternatively, content router 16 may include software (or reciprocating software) that can coordinate with other network elements in order to achieve the support of different URL formats described herein. In still other embodiments, one or several devices may include any suitable algorithms, hardware, software, components, modules, interfaces, or objects that facilitate the operations thereof.

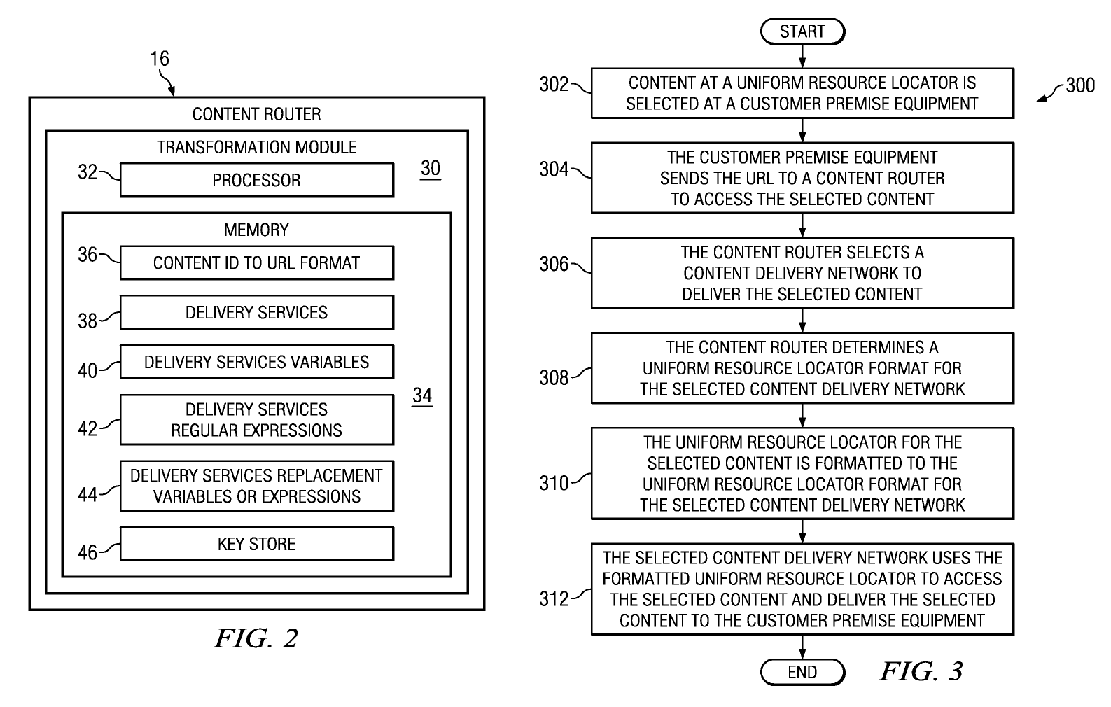

Turning to FIG. 2, FIG. 2 is a simplified block diagram illustrating one possible set of details associated with communication system 10. This particular configuration includes content router 16. In this particular implementation, content router 16 includes transformation module 30. Transformation module 30 can include a processor 32, and a memory 34. Memory 34 may include a content ID to URL format database 36, delivery services 38, delivery services variables 40, delivery services regular expressions 42, delivery services replacement variables or expressions 44, and a key store 46.

Content ID to URL format database 36 can associate a content ID in a URL with a possible URL format. Delivery services 38 can include a list of delivery services that may be included in a URL. Delivery services variables 40 can include a map of a set of variables for each delivery service in delivery services 38. Delivery services regular expressions 42 can include a map of a set of regular expressions for each delivery service in delivery services 38. Delivery services replacement variables or expressions can include replacement parameters to be used when transforming or formatting a URL for a CDN. Key store 46 can be synchronized with original URL signatures so content router 16 can re-sign transformed URLs with an appropriate signature.

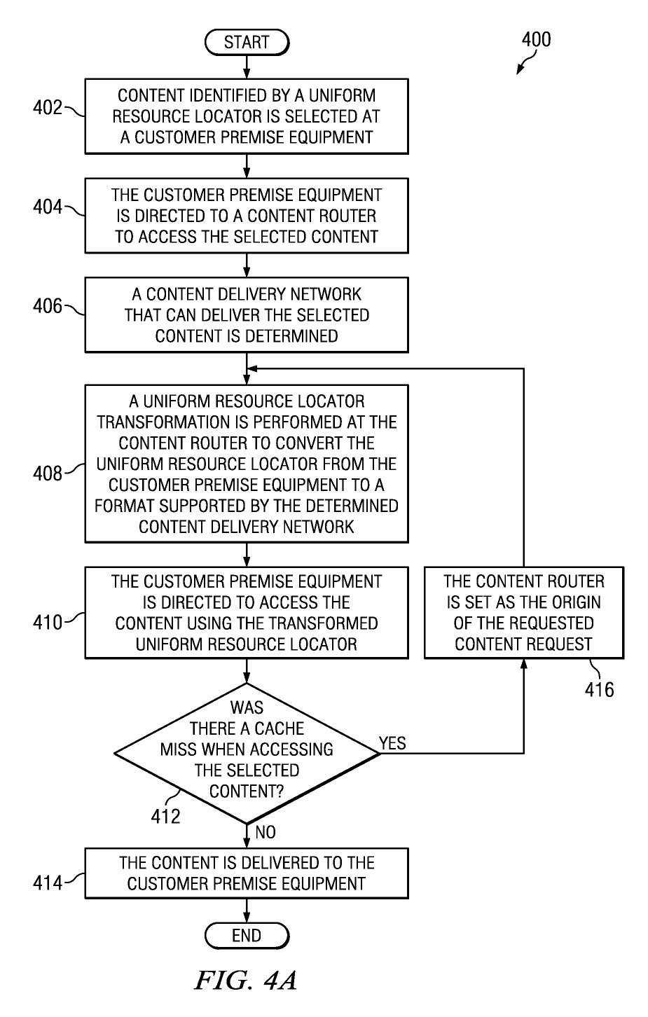

Turning to FIG. 3, FIG. 3 is a simplified flowchart 300 illustrating example activities associated with supporting different uniform resource locator formats for the same content on different network elements. At 302, content at a URL is selected at a CPE. For example, a user may select to view content on CPE 22 and the location of the content is at content source 12 and identified by a URL. At 304, the CPE sends the URL to a content router to access the selected content. For example, CPE 22 may send the URL to content router 16 to access the selected content at content source 12. At 306, the content router selects a CDN to deliver the selected content. For example, content router 16 may select a CDN in network 18 to deliver the selected content. At 308, the content router determines a URL format for the selected CDN. For example, content router 16 may determine the URL format for the selected CDN in network 18. At 310, the URL for the selected content is formatted to the URL format for the selected CDN. For example, content router 16 may format the URL from the CPE 22 to the URL format for the selected CDN in network 18. At 312, the CDN uses the formatted URL to access the selected content and deliver the selected content to the CPE. For example, the selected CDN in network 18 may use the formatted URL to access the selected content on content source 12 and then deliver the content to CPE 22.

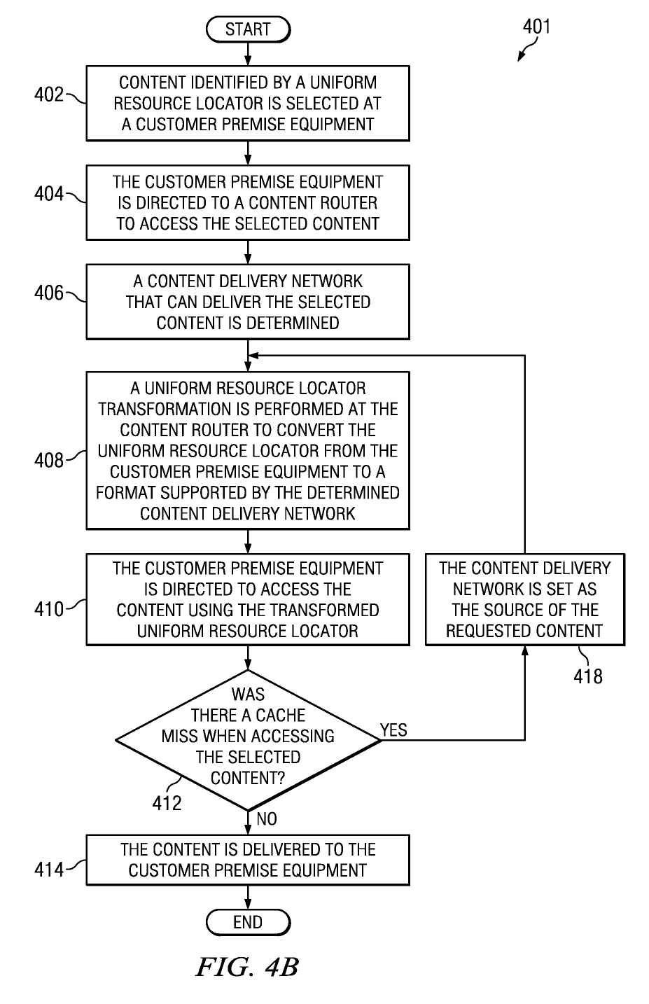

Turning to FIG. 4A, FIG. 4A is a simplified flowchart 400 illustrating example activities associated with supporting different uniform resource locator formats for the same content on different network elements. At 402, content identified by a URL is selected at a CPE. For example, a user may use CPE 22 to select content on content source and identified by a URL. At 404, the CPE is directed to a content router to access the selected content. For example, CPE 22 may be directed to content router 16 to access the selected content. At 406, a CDN that can deliver the selected content is determined. For example, a CDN in network 18 that can deliver the selected content to CPE 22 may be determined.

At 408, a URL transformation is performed at the content router to convert the URL from the CPE to a format supported by the determined CDN. For example, content router 16 may transform the URL received from CPE 22 into a URL supported by the determined CDN in network 18. At 410, the CPE is directed to access the content using the transformed URL. For example, content router 16 may send CPE 22 the transformed URL and the determined CDN in network 18 so CPE 22 can use the transformed URL to access the content from content source 12 using the determined CDN in network 18.

At 412, the system determines if there was a cache miss when accessing the selected content. If the system determines that there was not a cache miss when accessing the selected content, then the content is delivered to the CPE, as illustrated in 414. If the system determines that there was a cache miss, then the content router is set as the origin of the requested content request, as illustrated in 416. For example, content router 16 may designate itself as the origin of the content request.

Turning to FIG. 4B, FIG. 4B is a simplified flowchart 401 illustrating example activities associated with supporting different uniform resource locator formats for the same content on different network elements. At 402, content identified by a URL is selected at a CPE. For example, a user may use CPE 22 to select content on content source and identified by a URL. At 404, the CPE is directed to a content router to access the selected content. For example, CPE 22 may be directed to content router 16 to access the selected content. At 406, a CDN that can deliver the selected content is determined. For example, a CDN in network 18 that can deliver the selected content to CPE 22 may be determined.

At 408, a URL transformation is performed at the content router to convert the URL from the CPE to a format supported by the determined CDN. For example, content router 16 may transform the URL received from CPE 22 into a URL supported by the determined CDN in network 18. At 410, the CPE is directed to access the content using the transformed URL. For example, content router 16 may send CPE 22 the transformed URL and the determined CDN in network 18 so CPE 22 can use the transformed URL to access the content from content source 12 using the determined CDN in network 18.

At 412, the system determines if there was a cache miss when accessing the selected content. If the system determines that there was not a cache miss when accessing the selected content, then the content is delivered to the CPE, as illustrated in 414. If the system determines that there was a cache miss, then the CDN is set as the source of the requested content, as is illustrated in 418.

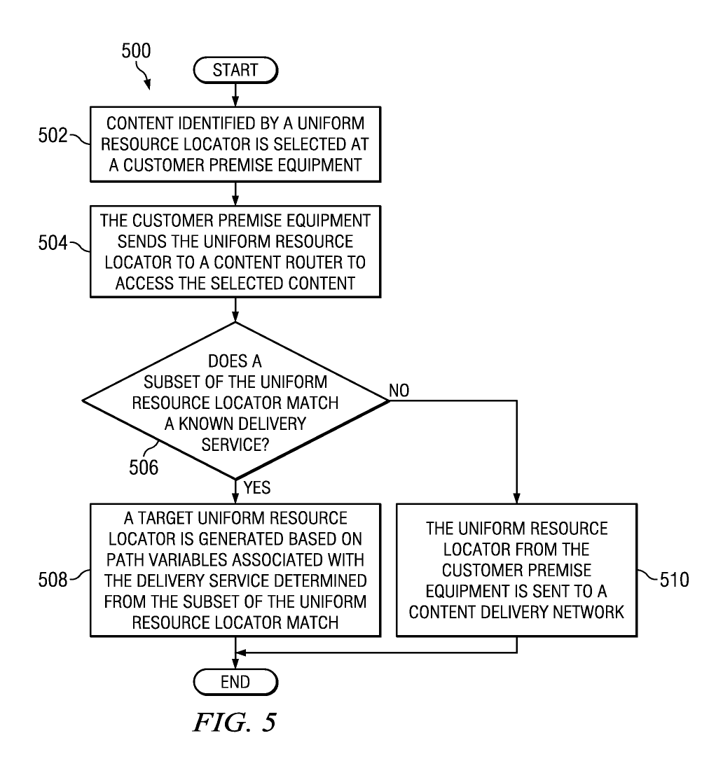

Turning to FIG. 5, FIG. 5 is a simplified flowchart 500 illustrating example activities associated with supporting different uniform resource locator formats for the same content on different network elements. At 502, content identified by a URL is selected at a CPE. For example, content identified by a URL may be selected at CPE 22. At 504, the CPE sends the URL to a content router to access the selected content. For example, CPE 22 may send the URL to content router 16 to access the selected content.

At 506, the system determines if a subset of the URL matches a known delivery service. For example, the system may determine if a subset of the URL matches a known delivery service in delivery services 38 (in transformation module 30). If the system determines that a subset of the URL matches a known deliver service, then a target URL is generated based on patch variables associated with the delivery service determined from the subset of the URL match, as illustrated in 508. If the system determines that a subset of the URL does not match a known deliver service, then the URL from the CPE is sent to a CDN, as illustrated in 510.

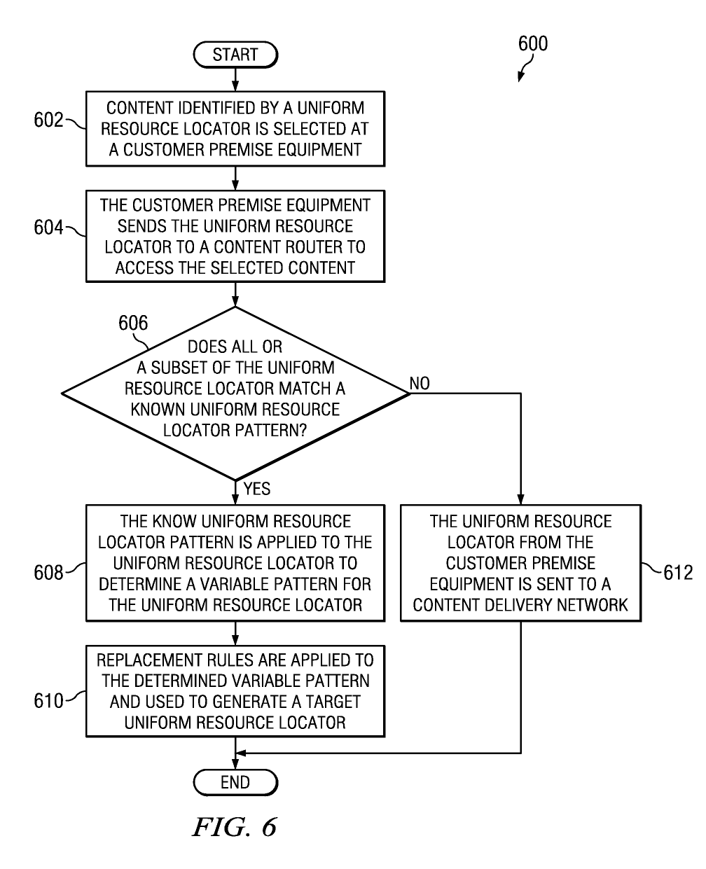

Turning to FIG. 6, FIG. 6 is a simplified flowchart 600 illustrating example activities associated with supporting different uniform resource locator formats for the same content on different network elements. At 602, content identified by a URL is selected at a CPE. At 604, the CPE sends the URL to a content router to access the selected content. For example, CPE 22 may send the URL to content router 16 to access the selected content from content source 12. At 606, the system can if a subset of the URL matches a URL pattern (e.g., within delivery services regular expressions 42 in transformation module 30). If all or a subset of the URL matches a known URL pattern, then the know URL pattern is applied to the URL to determine a variable pattern for the URL, as illustrated at 608. At 610, replacement rules are applied to the determined variable pattern and used to generate a target URL. If all or a subset of the URL does not match a known URL pattern, then the URL from the CPE is sent to a CDN, as illustrated in 610.

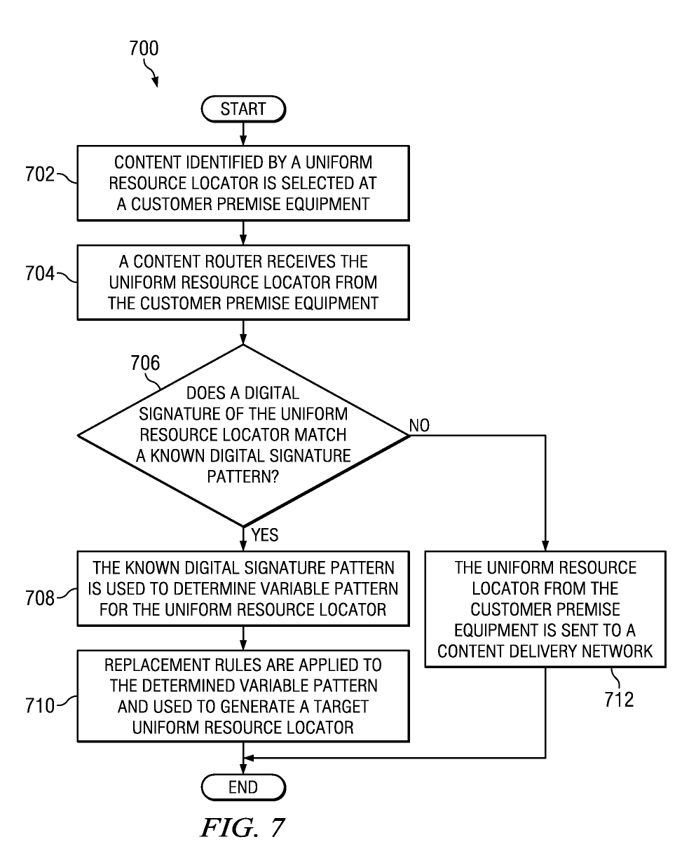

Turning to FIG. 7, FIG. 7 is a simplified flowchart 700 illustrating example activities associated with supporting different uniform resource locator formats for the same content on different network elements. At 702, content identified by a URL is selected at a CPE. For example, content identified by a URL may be selected at CPE 22. At 704, a content router receives the URL from the CPE. At 706, the system may determine if a digital signature of the URL matches a known digital signature or key (e.g., within key store 46 in transformation module 30).

If the system determines the digital signature of the URL matches a known digital signature pattern, then the known digital signature pattern is used to determine a variable pattern for the URL, as illustrated in 708. At 710, replacement rules are applied to the determined variable pattern and used to generate a target URL. If the system determines the digital signature of the URL does not match a known digital signature pattern, then the URL from the CPE is sent to a CDN, as illustrated in 712.

As identified previously, a network element can include software (e.g., transformation module 30, etc.) to achieve supporting different URL formats, as outlined herein in this document. In certain example implementations, the supporting different URL formats functions outlined herein may be implemented by logic encoded in one or more tangible, non-transitory media (e.g., embedded logic provided in an application specific integrated circuit [ASIC], digital signal processor [DSP] instructions, software [potentially inclusive of object code and source code] to be executed by a processor [processor 32 shown in FIG. 2], or other similar machine, etc.). In some of these instances, a memory element [memory 34 shown in FIG. 2] can store data used for the operations described herein. This includes the memory element being able to store instructions (e.g., software, code, etc.) that are executed to carry out the activities described in this Specification. The processor (e.g., processor 32) can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Any of these elements (e.g., the network elements, etc.) can include memory elements for storing information to be used in supporting different URL formats as outlined herein. Additionally, each of these devices may include a processor that can execute software or an algorithm to perform the supporting different URL formats activities as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Note that with the examples provided above, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that communication system 10 (and its teachings) are readily scalable and, further, can accommodate a large number of components, as well as more complicated/sophisticated arrangements and configurations. Accordingly, the examples provided should not limit the scope or inhibit the broad teachings of communication system 10, as potentially applied to a myriad of other architectures.

It is also important to note that the steps in the preceding FIGURES illustrate only some of the possible scenarios that may be executed by, or within, communication system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving a uniform resource locator (URL) at a content router;
selecting at least a portion of at least a portion of a content delivery network to access content associated with the URL; and
formatting the URL that was received based on the portion of the portion of the content delivery network that was selected.

2. The method of claim 1, further comprising:
parsing a source URL to extract a delivery service to format the URL that was received.

3. The method of claim 2, further comprising:
evaluating associated variables for the delivery service;
applying a replacement pattern that utilizes the variables; and
using the replacement pattern to construct a target URL format for a subsequent communication to the portion of the content delivery network.

4. The method of claim 1, wherein a digital signature pattern that matches a digital signature of the URL is used to format the URL.

5. The method of claim 4, further comprising:
validating the digital signature of the URL that was received by comparing the digital signature to a signature variable, wherein if no match exists between the signature variable and the digital signature, then a request for content is rejected.

6. The method of claim 1, further comprising:
determining if the digital signature matches a known digital signature pattern; and
using the known digital signature pattern to determine a variable pattern for the URL.

7. The method of claim 1, further comprising:
configuring a content router with a list of delivery services;
receiving a routing request; and
matching a selected one of the delivery services with a subset of the URL by performing a string comparison.

8. The method of claim 1, further comprising:
defining a set of regular expressions;
applying a selected one of the regular expressions to the URL; and
extracting a delivery service name based on the selected one of the regular expressions.

9. The method of claim 1, further comprising:
determining a cache miss; and
using the content router as an origin for particular content requested by a particular content delivery network.

10. Logic encoded in one or more non-transitory media that includes instructions for execution and when executed by a processor is configured to perform operations, comprising:
receiving a uniform resource locator (URL) at a content router;
selecting at least a portion of a content delivery network to access content associated with the URL; and
formatting the URL that was received based on the portion of the content delivery network that was selected.

11. The logic of claim 10, wherein the operations further comprise:
parsing a source URL to extract a delivery service to format the URL that was received.

12. The logic of claim 11, wherein the operations further comprise:
evaluating associated variables for the delivery service;
applying a replacement pattern that utilizes the variables; and
using the replacement pattern to construct a target URL format for a subsequent communication to the portion of the content delivery network.

13. The logic of claim 10, wherein a digital signature pattern that matches a digital signature of the URL is used to format the URL.

14. The logic of claim 10, wherein the operations further comprise:
validating the digital signature of the URL that was received by comparing the digital signature to a signature variable, wherein if no match exists between the signature variable and the digital signature, then a request for content is rejected.

15. The logic of claim 10, wherein the operations further comprise:
determining if the digital signature matches a known digital signature pattern; and
using the known digital signature pattern to determine a variable pattern for the URL.

16. The logic of claim 10, wherein the operations further comprise:
configuring a content router with a list of delivery services;
receiving a routing request; and
matching a selected one of the delivery services with a subset of the URL by performing a string comparison.

17. The logic of claim 10, wherein the operations further comprise:
defining a set of regular expressions;
applying a selected one of the regular expressions to the URL; and
extracting a delivery service name based on the selected one of the regular expressions.

18. The logic of claim 10, wherein the operations further comprise:
determining a cache miss; and
using the content router as an origin for particular content requested by a particular content delivery network.

19. An apparatus, comprising:
a processor coupled to a memory element, wherein the apparatus is configured for:
receiving a uniform resource locator (URL) at a content router;
selecting at least a portion of a content delivery network to access content associated with the URL;
formatting the URL that was received based on the portion of the content delivery network that was selected; and.
parsing a source URL to extract a delivery service to format the URL that was received.

20. The apparatus of claim 19, wherein the apparatus is further configured for:
evaluating associated variables for the delivery service;
applying a replacement pattern that utilizes the variables; and
using the replacement pattern to construct a target URL format for a subsequent communication to the portion of the content delivery network.
